(19) United States
(12) Patent Application Publication
(10) Pub. No.: US 2010/0262665 A1
(43) Pub. Date: Oct. 14, 2010

(54) CLASSIFIED PROCESSING METHOD FOR EVENT MESSAGE OF INFORMATION HOUSEHOLD APPLIANCES

(75) Inventors: Congxing Ouyang, Beijing (CN); Guanghai Zhang, Beijing (CN); Jinglei Liu, Beijing (CN)

Correspondence Address: FULBRIGHT & JAWORSKI L.L.P, 2200 ROSS AVENUE, SUITE 2800, DALLAS, TX, 75201-2784, US

(73) Assignee: China Mobile Communications Corporation, Beijing (CN)

(21) Appl. No.: 12/665,289

(22) PCT Filed: Jun. 29, 2007
(86) PCT No.: PCT/CN2007/002042

§ 371 Date: Jun. 30, 2010

(51) Int. Cl. G06F 9/46; G06F 15/16

(52) U.S. Cl. 709/206; 719/318

(57) ABSTRACT

The invention provides a classified processing method for an event message of an information household appliance including: a house gateway server sends an event occurrence message to an information household appliance data management server; according to an event class and a policy of classified notification of event, the information household appliance data management server sends an event occurrence notification message to an instant communication terminal, or sends an event occurrence notification message to an instant communication terminal and notifies a communication device at a preset communication destination; according to an event class and a policy of classified prompt, the instant communication terminal performs an operation of prompting the user. The method in the invention, the user can obtain the current status of the information household appliances, and the user or the related department may know the emergency or abnormal events in time, thus reducing the potential threat against safety.

### FIELD OF INVENTION

The present invention relates to a method of processing messages, and in particular, to a method, in which the messages of various events of information household appliances are classified for processing by means of instant messaging.

### BACKGROUND OF THE INVENTION

With the developments of network technologies and household appliances industry, household appliances can now be connected to a network. Such household appliances that may be connected to a network are called information household appliances, or network household appliances. Information household appliances can receive data from a network and return their status information to the network. The appearance of information household appliances enables a user to obtain data of the information household appliances in home via the Internet, thus enabling the user to know the status of the information household appliances without being at home.

There are two methods for the user to obtain the status of the information household appliances in the prior art. One of the two methods is to obtain the status information of the information household appliances by accessing the information household appliances through a point-to-point based mode; the other is to obtain the status information of the information household appliances by accessing servers in a network through a web page based mode. Both methods require the user to actively obtain the status information, causing much inconvenience for the user. The status of information household appliances in the household may be changed at any moment, in this case, a large amount of status information may be generated. However, it is not necessary for the user to obtain every status change of the information household appliances. For example, the user need not know the normal status changes of the information household appliances (e.g. a temperature change within a normal preset range that is detected by an air conditioner in the household) in real time. The various status information is not classified suitably in the prior art and the user is required to obtain the status information actively, thus, the user is required to select useful status information from the vast information, which is difficult for the user and the efficiency is very low. Furthermore, the user cannot obtain instantly an abnormal status change of information household appliances that indicates a danger (e.g. the case detected by the household air conditioner where the temperature exceeds the normal temperature range, which may imply a risk of fire). In the case of the abnormal status change, not only the user but also the related department (such as the fire-fighting office, administrative personnel of the residential quarter) needs to be notified of the danger, which cannot be achieved in the prior art, as a result, the potential thread against the safety cannot be eliminated.

### SUMMARY OF THE INVENTION

The purpose of the present invention is to provide a classified processing method for an event message of an information household appliance, in which event occurrence notification message is transmitted, by means of instant communication, to an instant communication terminal or to an instant communication terminal and a preset communication destination, according to the class of information household appliances event, so that the user can obtain the current status of the information household appliance conveniently, in particular, when an emergency or abnormal event happen, the user or the related department may know the events in time, thus reducing potential threat against the safety.

In order to fulfill the above purpose of the present invention, an embodiment of the present invention provides a classified processing method for an event message of an information household appliance, including:

Process 1: monitoring, by a household gateway server, status of an information household appliance in real time, and when detecting that an event of the information household appliance occurs, sending an event occurrence message including event content information of the event to an information household appliance data management server;

Process 2: determining, by the information household appliance data management server, an event class of the event according to the event content information;

Process 3: according to the event class and a preset policy of classified notification of event, sending, by the information household appliance data management server, an event occurrence notification message including the event content information of the information household appliance to an instant communication terminal, or sending, by the information household appliance data management server, an event occurrence notification message including the event content information of the information household appliance to an instant communication terminal and notifying a communication device at a preset communication destination;

Process 4: determining, by the instant communication terminal, an event class of the event according to the event content information;

### DETAILED DESCRIPTION OF THE INVENTION

Process 5: performing, by the instant communication terminal, an operation of prompting user according to the event class and a preset policy of classified prompt.

By using the method provided by the present invention, the user can conveniently obtain the current status of the information household appliances. With the use of the classified notification of events and the policy of classified prompt of events, the user can effectively know the key status change information of the information household appliances. Furthermore, when the emergency or abnormal events happen, the user or the related department may know the events in time, thus reducing the potential threat against safety.

The present invention is further described in detail through drawings and embodiments below.

### BRIEF DESCRIPTION OF THE DRAWINGS

FIG. 1 is a flowchart of a classified processing method for an event message of information household appliances according to an embodiment of the present invention;

FIG. 2 is a schematic illustration of the structure of a data storage system for information household appliances according to an embodiment of the present invention;

FIG. 3 is a schematic illustration of the structure of a data storage system based on an IMS network and an IP access network according to an embodiment of the present invention.

### DETAILED DESCRIPTION OF THE EMBODIMENTS

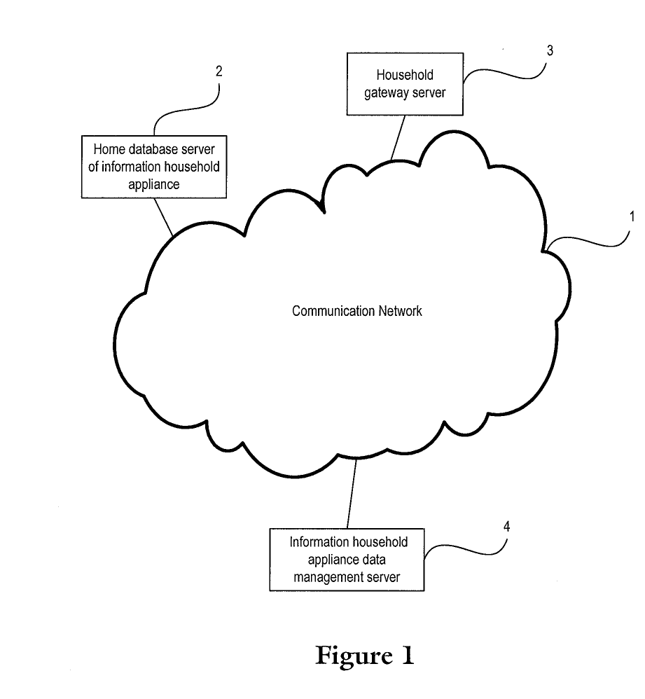

The method according to an embodiment of the present invention is implemented based on a data storage system for information household appliances. Referring to FIG. 1, a schematic illustration of the structure of a data storage system for information household appliances according to an embodiment of the present invention is shown. The data storage system includes:

a communication network 1, which may be an IP based communication network in a practical application; one or more home database servers of information household appliance 2, which are connected to the communication network 1 and configured for storing static data of the information household appliances, where the static data is generated when the information household appliances are manufactured, associated with the information household appliances and not modified with the use of the information household appliances, further, the static data includes at least an identification code of the information household appliance; one or more household gateway servers 3, which are connected to the communication network 1 and configured for monitoring the status of information household appliances connected to the household gateway server 3 in real time; one or more information household appliance data management servers 4, which are connected to the communication network 1 and configured for storing operation data of operative information household appliances, where the operation data includes at least static data and current operation status data of the information household appliances, as well as address information of the household gateway server corresponding to the information household appliances.

In the embodiment of the present invention, the data storage model of personal communication is introduced to the data storage of information household appliances. Each information household appliance device is allocated with a code by the manufacturer in the factory. The allocated code should be in a standard format, and should be able to uniquely identify the information household appliance device globally, thus, the code is called as ID (identification code) of the information household appliance. The ID of the information household appliance, which is similar to a mobile telephone number in personal communication, is carried during the information exchange related to the information household appliance in the network. The ID can be used to locate the home database server of information household appliance that is associated with the information household appliance, and the ID of the information household appliance is stored in both the information household appliance and the home database server of information household appliance. Furthermore, the manufacturer of the information household appliance also provides other static data of the information household appliance, for example including a device brand, a device name, a device model, a manufacture serial number, default configuration information of the device in the factory, and a set of control instructions and a set of status supported by the device. The static data is stored in the home database server of information household appliance once the appliance leaves the factory. In the case of data storage mode of the information household appliances in the prior art, the static data is stored in the information household appliance itself, but in the embodiment of the present invention, the static data does not need to be stored in the information household appliance itself, thus reducing the amount of data that needs to be stored in the information household appliance. The home database servers of information household appliance can be divided using several ways, for example, the home database servers of information household appliance may be divided according to manufacturer information of the information household appliances, or according to the types of the information household appliances. Correspondingly, the ID of the information household appliance can be encoded similarly, so that the home database server of information household appliance associated with the information household appliance can be identified and located by analyzing the ID of the information household appliance.

An information household appliance data management server manages at least one household gateway server, while the household gateway server manages all information household appliances in the household. The information household appliance data management server stores operation data of all operative information household appliances managed by the household gateway server. Furthermore, in the information household appliance data management server, the data of the information household appliances is organized in a household gateway server basis. In the embodiment of the present invention, any information household appliance is connected to the household gateway server. One household gateway server can be provided in any household, and all of the information household appliances in the household can be connected to the household gateway server, so that the household gateway server may manage all the information household appliances in the household, and monitor the status of every information household appliance in real time. The household gateway server stores the data of all the operative information household appliances in the household, and synchronizes with the data stored in the information household appliance data management server, in this case, on one hand, information household appliances can be easily managed through the household gateway server in the household, on the other hand, when the household gateway server is disconnected from an external network, the data of the information household appliances can still be stored, and the data stored in the information household appliance data management server can be updated once the network connection is restored. The information household appliance data management server and the household gateway server store the data of operative information household appliances. When a new information household appliance is connected to the household gateway server, the information household appliance reports its ID to the information household appliance data management server through the household gateway server, and the static data of the information household appliance can be obtained from the home database server of information household appliance according to the ID of the information household appliance. The static data is stored in both the information household appliance data management server and the household gateway server.

In order to identify information of the information household appliance, an instant communication terminal needs to store the static data of the information household appliance. The instant communication terminal may obtain the static data of the information household appliance in various ways, for example, in an instant communication way that the information household appliance data management server actively pushes the static data of the information household appliance to the instant communication terminal when the information household appliance become on-line, or in a way that the instant communication terminal actively accesses the information household appliance data management server to obtain the static data of the information household appliance. The static data of the information household appliance includes a set of status of the information household appliance. The status set of the information household appliance includes contents of all events of the information household appliance, that is, the definition of various events of the information household appliance.

The status set of the information household appliance further includes an event class ID of the information household appliance, which is an attribute of the event of the information household appliance. There are many kinds of information household appliances and the events of the information household appliances are numerous, so the events of the information household appliances may be classified and each event class may be given an event class ID, in order to implement the classified notification of the various events of the information household appliances. The event class ID can be defined when the information household appliance is manufactured. According to the uniform event classification policy of the information household appliance, the events of the information household appliance are classified when the information household appliance is manufactured, and each event class is given an event class ID, which is stored in the status set of the information household appliance as an attribute of the event of the information household appliance. The event class ID is stored in the home database server of information household appliance as a part of the static data of the information household appliance. After the information household appliance is put into use, the event class IDs of the various information household appliance events may be modified according to specific applications, and the modification needs to be notified to the instant communication terminals or other related servers in the network that receive the information household appliance event information. But the static data stored in the home database server of information household appliance is not modified. That is, any event of the information household appliance has a default event class ID, but the event class ID corresponding to an event of the information household appliance can be reset through modifying the static data of the information household appliance stored in the information household appliance data management server, thus implementing the classified notification of the information household appliance events. After receiving an event occurrence message including event content information from a household gateway, the information household appliance data management server queries the static data of the information household appliance according to the event content information, obtains the event class ID of the event and determines the event class according to the event class ID. Likewise, an instant communication terminal determines the event class in the same way after receiving an event occurrence notification message including the event content information.

In the embodiment of the present invention, the event of the information household appliance is notified in the form of a message to the user via the instant communication based way, in which a server in the network actively push the message to the device corresponding to the subscriber according to the information of the subscriber. The user using the instant communication terminal is the subscriber, and the instant communication terminal is the device corresponding to the subscriber. The information household appliance data management server sends the event notification message to the instant communication terminal used by the user through querying the information of the user who has subscribed to the event of the information household appliance.

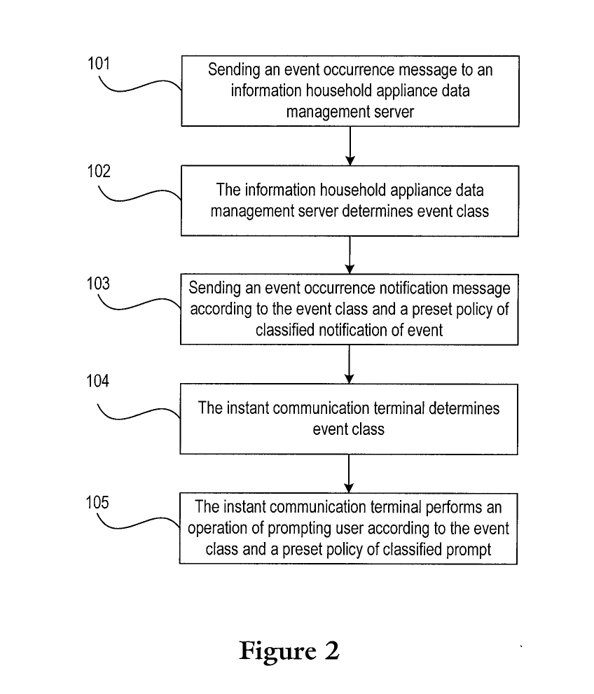

Referring to FIG. 2, a flowchart of a classified processing method for an event message of information household appliances according to an embodiment of the present invention is shown, and the method includes the following.

Process 101: A household gateway server monitors the status of an information household appliance in real time, and sends an event occurrence message to an information household appliance data management server when detecting an event of the information household appliance. The event occurrence message may include event content information of the event. The event includes any change of the status of the information household appliance, such as getting on-line of the information household appliance (that is, an on-line event is that the information household appliance is connected to the household gateway server), getting off-line of the information household appliance (that is, an off-line event is that the information household appliance is disconnected from the household gateway server), the change of the status data.

Process 102: The information household appliance data management server determines the event class of the event according to the event content information.

Process 103: According to the event class and a preset policy of classified notification of event, the information household appliance data management server sends an event occurrence notification message including the event content information of the information household appliance to an instant communication terminal, or, sends an event occurrence notification message including the event content information of the information household appliance to an instant communication terminal and notifies a communication device at a preset communication destination. The policy of classified notification of event may be flexibly set depending on the practical requirements.

In a specific application, the events of the information household appliance are divided into three classes including normal events, abnormal events and emergency alarm events, according to an embodiment of the present invention.

1. A normal event refers to a normal operation event, such as getting on-line of the information household appliance, actively getting off-line of the information household appliance, power on of the information household appliance, power off of the information household appliance, execution of a certain functional operation by the information household appliance.

2. An abnormal event includes, for example, passively getting off-line of the information household appliance, detection of an exception or failure of the information household appliance by the household gateway server, and any event of newly getting on-line detected by the household gateway server.

3. An emergency alarm event refers to an emergency event, such as a dangerous situation detected by the household gateway server.

The normal event and the abnormal event are non-emergency alarm event. The corresponding policy of classified notification is as follows: if the event class indicates a non-emergency alarm event, the information household appliance data management server sends an event occurrence notification message to the instant communication terminal; if the event class indicates an emergency alarm event, the information household appliance data management server sends the event occurrence notification message including the event content information of the information household appliance to the instant communication terminal and notifies the communication device at the preset communication destination, for example, notifies an emergency service station about the event via an emergency call, calls an emergency service telephone of the residential quarter, or notifies other preset communication terminals (such as the mobile telephone of a security guard of the residential quarter where the information household appliance is). Therefore, once an emergency event happens, the related persons or departments may know the event in time, so that appropriate measures can be adopted to deal with the event, and potential threat against safety can be reduced.

Notifying the communication device at the preset communication destination may be implemented by sending the event occurrence notification message including the event content information of the information household appliance, for example, sending the event occurrence notification message to the emergency service station in the network, where the static data and the dynamic data of the information household appliance need to be also stored in the emergency service station in the network, so that the emergency service station can identify the event occurrence notification message and further obtain the information of the geographical location of the information household appliance from the dynamic data. Furthermore, notifying the communication device at the preset communication destination may be implemented by a direct notification, for example, by directly sending a fire alarm signal to the communication device of the fire-fighting department, with the information of the geographical location of the information household appliance being carried. The geographical location information of the information household appliance may be determined from the household gateway server associated with the information household appliance, because the geographical location of the household gateway server is definitive. The related information of the household gateway server associated with the information household appliance is stored in the information household appliance data management server, and the related information of the household gateway server is a part of the dynamic data of the information household appliance.

Process 104: The instant communication terminal determines the event class of the event according to the event content information.

Process 105: The instant communication terminal performs an operation of prompting the user according to the event class and a preset policy of classified prompt. The policy of classified prompt may be flexibly set as desired. For example, the operation of prompting the user may be performed using the following policy of classified prompt: if the event class indicates a normal event, the instant communication terminal stores the information of the normal event, and presents the information of the normal event to the user when receiving an instruction to browse information of events of the information household appliance from the user; if the event class indicates an abnormal event, the instant communication terminal presents the information of the abnormal event to the user via active prompt, for example, the instant communication terminal may actively show the information of the event on its screen; however, the information may unnecessarily be processed by the user and may automatically disappear on the screen after a preset time (e.g., 5 seconds); furthermore, when browsing the information household appliance via the instant communication terminal, the user can obtain the notification of the event; if the event class indicates an emergency alarm event, the instant communication terminal presents the information of the emergency alarm event to the user via forced prompt, for example, the instant communication terminal may actively show the information of the event on its screen, and plays an alarm prompt sound via a speaker until it receives the confirming information inputted by the user.

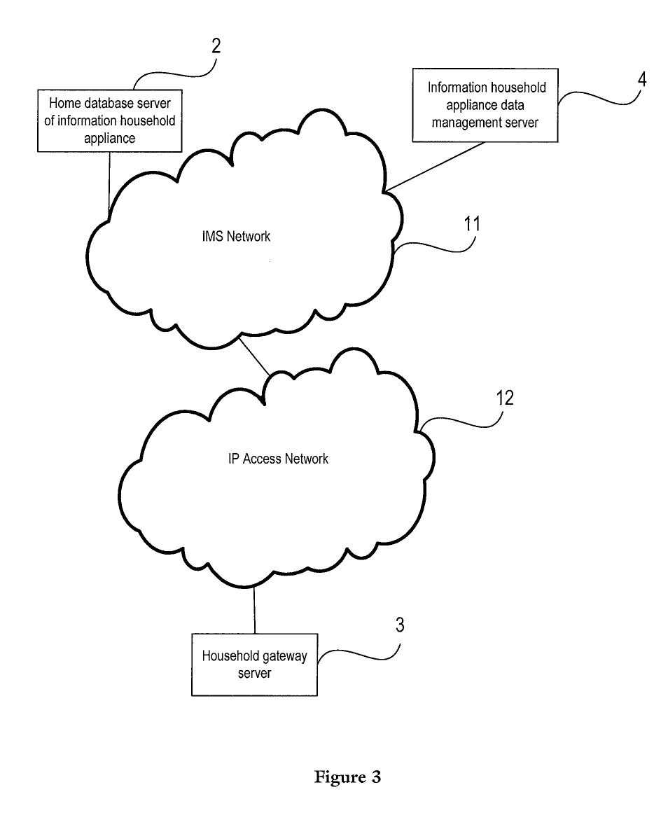

In order to implement the better instant communication of the information household appliances, the network structure showed in FIG. 3 may be used, in which a communication network 1 consists of an IP multimedia subsystem (IMS) network 11 and an IP access network 12 connected to each other. A home database server of information household appliance 2 and an information household appliance data management server 4 are both connected to the IMS network 11. A household gateway server 3 is connected to the IP access network 12. The advantage of instant communication may be better utilized through the IMS network.

It will be appreciated that the above embodiments are only used to describe the technical solutions of the present invention, but not used to impose any restriction or limit to the present invention. Despite the present invention has been elaborately described with reference to the above embodiments, it should be understood by one skilled in the art that it is still possible to modify or alternate equivalently the technical solutions described in the above embodiments, without departing from the spirit and scope of the technical solutions of the present invention.

1. A classified processing method for an event message of an information household appliance, comprising:
Process 1: monitoring, by a household gateway server, status of an information household appliance in real time, and when detecting that an event of the information household appliance occurs, sending an event occurrence message including event content information of the event to an information household appliance data management server;
Process 2: determining, by the information household appliance data management server, an event class of the event according to the event content information;
Process 3: according to the event class and a preset policy of classified notification of event, sending, by the information household appliance data management server, an event occurrence notification message including the event content information of the information household appliance to an instant communication terminal, or sending, by the information household appliance data management server, an event occurrence notification message including the event content information of the information household appliance to an instant communication terminal and notifying a communication device at a preset communication destination;
Process 4: determining, by the instant communication terminal, an event class of the event according to the event content information;
Process 5: performing, by the instant communication terminal, an operation of prompting user according to the event class and a preset policy of classified prompt.

2. The method of claim 1, wherein in the Process 3, if the event class indicates a non-emergency alarm event, the information household appliance data management server sends the event occurrence notification message to the instant communication terminal.

3. The method of claim 1, wherein in the Process 3, if the event class indicates an emergency alarm event, sending the event occurrence notification message including the event content information of the information household appliance to the instant communication terminal and notifying the communication device at the preset communication destination.

4. The method of claim 1, wherein in the Process 5, if the event class indicates a normal event, the instant communication terminal stores the event content information of the normal event, and presents the event content information of the normal event to the user when receiving an instruction of browsing the event information of the information household appliance inputted by the user.

5. The method of claim 1, wherein in the Process 5, if the event class indicates an abnormal event, the instant communication terminal presents the information of the abnormal event to the user via active prompt.

6. The method of claim 1, wherein in the Process 5, if the event class indicates an emergency alarm event, the instant communication terminal presents the event content information of the emergency alarm event to the user via forced prompt.

7. The method of claim 1, wherein in the Process 2, the information household appliance data management server queries static data of the information household appliance according to the event content information, obtains an event class ID of the event, and determines the event class according to the event class ID.

8. The method of claim 1, wherein in the Process 4, the instant communication terminal queries static data of the information household appliance according to the event content information, obtains an event class ID of the event, and determines the event class according to the event class ID.
